(19) United States
(12) Patent Application Publication
(10) Pub. No.: US 2025/0227444 A1
(43) Pub. Date: Jul. 10, 2025

(54) COMMUNICATING POWER CAPABILITIES OF AN ENERGY HARVESTING DEVICE

(71) Applicant: SHARP KABUSHIKI KAISHA, Sakai City (JP)

(72) Inventor: Kenneth James Park, Cathlamet, WA (US)

(21) Appl. No.: 18/409,659

(22) Filed: Jan. 10, 2024

(51) Int. Cl. H04W 4/70; H04B 7/24

(52) U.S. Cl. CPC H04W 4/70; H04B 7/24

(57) ABSTRACT

An energy harvesting electronic device includes an energy storage device and a processor that is configured to receive a first message from another electronic device requesting the transmission of a first data object and determine a first amount of energy required for transmitting the first data object and a second amount of energy required for receiving a second message from the other electronic device. After determining that the amount of stored energy is sufficient for transmitting the first data object, the processor determines, based on the second amount of energy, whether the remaining amount of energy after transmitting the first object is sufficient for receiving the second message, sets an indicator to indicate whether or not the remaining amount of energy stored in the energy storage device after transmitting the first object is sufficient, and transmits the first data object and the indicator to the other electronic device.

### TECHNICAL FIELD

The technology generally relates to wireless communications, and more particularly, to communicating power capabilities of an energy harvesting device in a wireless network.

### BACKGROUND

One of the three fundamental use cases for development of the 3rd Generation Partnership Project 5th Generation Mobile Network (3GPP 5G) technologies is Narrowband Internet of Things/machine type communications (NB-IoT/MTC). The NB-IoT is a standards-based low power wide area (LPWA) technology that is developed to enable a wide range of new IoT devices and services. NB-IoT significantly improves the power consumption of user devices, system capacity, and spectrum efficiency, especially in deep coverage.

Some of the IoT devices may achieve a battery life of more than 10 years, which may be desirable in a wide range of use cases. New physical layer signals and channels are designed for 3GPP New Radio (NR) to meet the demanding requirement of extended coverage (e.g., for rural and deep indoors application) and ultra-low device complexity. The initial cost of the NB-IoT devices is expected to be a significant market driver for the uptake of this technology. The underlying technology of the NB-IoT devices is, however, much simpler than the existing solutions and its cost is expected to decrease rapidly as demand increases.

The MTC, also referred to as machine to machine (M2M), represents the broad area of wireless communication with sensors, actuators, physical objects, and other devices that are not directly operated by humans. The MTC communication denotes a data channel between two entities without the involvement of a human. This communication is typically between an MTC device and an MTC server. A prime example of MTC communication is the smart metering for utility services such as gas, water, and electricity. The MTC communication may also be between the MTC devices (e.g., IoT devices), without the involvement of an MTC server.

An ambient power-enabled Internet of Things (ambient power-enabled IoT or AIoT) device is an IoT device that is powered by energy harvesting. The harvested power may be obtained from the energy that is inherently available in the device's environment. Typically, an energy harvesting wireless terminal may not have a conventional battery, and the device may use energy harvested from the environment in lieu of a dedicated internal power source.

Such a device may be capable of either harvesting, storing, and subsequently using, or harvesting and immediately using, energy from wireless radio waves or any other form of energy that may be locally obtained to meet the needs of a particular application. For example, in some scenarios, an AIoT device may harvest energy from radio waves that may come from 5G NR network entities (e.g., a next-generation Node B (gNB), or customer premise equipment (CPE)) or from user equipment (e.g., hand held devices or IoT devices). In some other scenarios, an AIoT device may harvest energy from solar, light, motion/vibration, heat, pressure, or any other potential energy sources.

The 3GPP (e.g., as indicated in Release 19 (Rel-19) of 3GPP Services and System Aspects (SA) Working Group 1 (WG1) (more commonly known as SA1)) has conducted an overall service description (e.g., in a stage 1 level study) on the support of ultra-low power applications. In the ultra-low power applications, the power requirements of a device may be satisfied from local energy harvesting by the device. For example, a device may include no battery and may derive sufficient operating energy from the local environment. The energy may be used either immediately or may be stored in a capacitor for later use. The study was preceded by an agreement in SA1 of a Work Item Description (WID) document. That document provides the justification of the work and an outline of the scope of the work that is expected to take place with respect to developing a Technical Report (TR). The latest revision of the WID may be found in SP-220085.

The results of the SA1 stage 1 study that was concluded in December 2022 were published in TR 22.840 v1.0.0 and the normative work was concluded in November of 2023. The study covered use cases, traffic scenarios, and device constraints of AIoT devices. The study identified new potential service requirements as well as new key performance indicators (KPIs) as related to 3GPP NR type devices, access network, and core network.

Massive MTC (mMTC) is one important use case for 5G that was discussed in the WID. However, there are still several important use cases and scenarios that are not adequately covered by 3GPP Rel-18 technologies. These uses cases include ultra-low complexity device, very small device size/form factor (e.g., thickness of mm) device, maintenance-free (e.g., no need to replace a conventional battery for the device) device, device longer life cycle, and device deployment where a conventional battery is not applicable.

To address at least the use cases above, the SA1 has conducted a study on IoT service using an IoT device powered by energy harvesting, where a device powered by such energy harvesting may support IoT communications without relying on conventional power source and/or avoiding human intervention for recharging or replacing. The study results may be found in SP-231405 and the resulting technical specification may be found in TS 22.369. In addition to the low power consumption of such AIoT device, the study also considers low device complexity, small device size, and a device with a long-life cycle.

Some of the potential challenges of AIoT devices may include: an extremely low complexity device form factor, the ability to harvest energy and at the same time use the harvested energy to support communication, the capability to provide sufficient communication services to fulfil the corresponding requirements, the capability to provide user privacy, and the capability to provide data security.

In many use cases, the life cycle of an AIoT device may need to be properly managed so as to meet user and institutional expectations. For example, when an AIoT device is deployed to track an item in a warehouse, the device may only be intended to be used when the tracked item is being transferred, stored, loaded/unloaded, and inventoried in the warehouse. Then, subsequent to its use in the warehouse, the device may be discarded. Thus, in the interests of protecting the privacy and security of information that may be retained on the device, the device may not be allowed access to, or access by, the 5GS when the device has come to the end of its intended use. In addition, the device may not be allowed access to, or access by, the 5GS when the device has come to an end of its intended use in order to avoid interference to other devices that may be using resources of the 5G system (5GS), such as Radio Frequency (RF) resources.

The 3GPP (e.g., as indicated in TS22.369) defines the communication aspects of an AIoT device as a functional service requirement as follows. The 5G system shall be able to support 5G network or an Ambient IoT capable UE to communicate with a group of Ambient IoT devices simultaneously. The 5G network shall support a mechanism to authorize an Ambient IoT capable UE to communicate with an Ambient IoT device. The 5G system shall be able to support mechanisms to communicate between an Ambient IoT device and the 5G network using Ambient IoT direct network communication or Ambient IoT indirect network communication, or between an Ambient IoT device and Ambient IoT capable UE using Ambient IoT device to UE communication. Examples of the communication between 5G network/Ambient IoT capable UE and Ambient IoT devices can include periodic sensor reporting or network-initiated inventory. The 5G system shall provide suitable mechanisms to support communication between a trusted and authorized 3rd party and an Ambient IoT device or group of Ambient devices.

### SUMMARY

In a first aspect of the present application, an energy harvesting electronic device is provided. The electronic device includes an energy storage device configured to store energy harvested by the electronic device. The electronic device includes one or more non-transitory computer-readable media storing one or more computer-executable instructions and at least one processor coupled to the one or more non-transitory computer-readable media. The at least one processor is configured to execute the one or more computer-executable instructions to cause the electronic device to receive a first message from another electronic device requesting a transmission of a first data object; determine a first amount of energy required for transmitting the first data object and a second amount of energy required for receiving a second message from the other electronic device after transmitting the first data object. The at least one processor is configured to execute the one or more computer-executable instructions to cause the electronic device to, after determining that, based on the first amount of energy, an amount of energy stored in the energy storage device is sufficient for transmitting the first data object: determine, based on the second amount of energy, whether a remaining amount of energy stored in the energy storage device after transmitting the first object is sufficient for receiving the second message; set an indicator to a first value in a case that the remaining amount of energy stored in the energy storage device after transmitting the first object is determined to be sufficient; set the indicator to a second value in a case that the remaining amount of energy stored in the energy storage device after transmitting the first object is determined to be insufficient; and transmit the first data object and the indicator to the other electronic device.

In an implementation of the first aspect, the remaining amount of energy stored in the energy storage device after transmitting the first object is a first remaining amount of energy stored in the energy storage device. The at least one processor is further configured to execute the one or more computer-executable instructions to cause the electronic device to determine a third amount of energy for transmitting a second data object in response to receiving the second message; and determine, based on the third amount of energy, whether a second remaining amount of energy stored in the energy storage device after receiving the second message is sufficient for transmitting the second data object. Setting the indicator to the second value further includes setting the indicator to the second value in a case that the second remaining amount of energy stored in the energy storage device after receiving the second message is determined to be insufficient.

In another implementation of the first aspect, the other electronic device is one of a base station (BS) and a user equipment (UE).

In another implementation of the first aspect, the other electronic device is configured not to transmit any messages to the energy harvesting electronic device for a threshold amount of time in a case that the indicator received from the energy harvesting device is set to the second value.

In another implementation of the first aspect, the indicator is a logical bit, the first value is one of 1 and 0, and the second value is the other one of 1 and 0.

In another implementation of the first aspect, a first parameter indicating a power required for transmitting first data and a second parameter indicating a power required for receiving second data are configured to the electronic device. Determining the first amount of energy includes determining the first amount of energy based on the first parameter and determining the second amount of energy includes determining the second amount of energy based on the second parameter.

In another implementation of the first aspect, the first and second parameters are configured to the electronic device at a time of manufacturing the electronic device.

In another implementation of the first aspect, the at least one processor is further configured to execute the one or more computer-executable instructions to cause the electronic device to receive a configuration message including one or more updated values for at least one of the first and second parameter; and reconfigure at least one of the first and second parameters with the one or more updated values.

In another implementation of the first aspect, receiving the configuration message includes receiving the configuration message via radio resource control (RRC) signaling.

In another implementation of the first aspect, the first data object includes a tracking identification of the electronic device.

In another implementation of the first aspect, the first message requesting the transmission of the tracking identification of the electronic device includes a request message broadcast by the other electronic device.

In another implementation of the first aspect, the request message broadcast by the other electronic device includes one of a device identification or a device group identification of the electronic device.

In another implementation of the first aspect, the energy storage device includes a capacitor.

In another implementation of the first aspect, the electronic device is an AIoT device.

In a second aspect of the present application, a method is provided. The method includes receiving a first message at an energy harvesting electronic device from another electronic device requesting the transmission of a first data object. The energy harvesting electronic device includes an energy storage device. The method includes determining a first amount of energy required for transmitting the first data object and a second amount of energy required for receiving a second message from the other electronic device after transmitting the first data object. The method includes, after determining that, based on the first amount of energy, an amount of energy stored in the energy storage device is sufficient for transmitting the first data object: determining, based on the second amount of energy, whether a remaining amount of energy stored in the energy storage device after transmitting the first object is sufficient for receiving the second message; setting an indicator to a first value in a case that the remaining amount of energy stored in the energy storage device after transmitting the first object is determined to be sufficient; setting the indicator to a second value in a case that the remaining amount of energy stored in the energy storage device after transmitting the first object is determined to be insufficient; and transmitting the first data object and the indicator to the other electronic device.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a wireless communication system, according to an example implementation of the present disclosure.

FIG. 2 is a diagram illustrating parameters related to subcarrier spacing, according to an example implementation of the present disclosure.

FIG. 3 illustrates a flowchart of an example method/process performed by an AIoT device to transmit an indication of whether the AIoT device has sufficient power to transmit or receive another message, according to an example implementation of the present disclosure.

FIG. 4 is a state diagram of an AIoT device for indicating whether the AIoT device has sufficient energy for subsequent message reception and transmission, according to an example implementation of the present disclosure.

FIG. 5 is a sequence diagram illustrating an example message flow for a wireless terminal to transmit an indication as to whether or not the AIoT device has sufficient energy for subsequent reception and transmission of messages, according to an example implementation of the present disclosure.

FIG. 6 is a flowchart illustrating an example method/process performed by a wireless terminal implementing the embodiments of FIGS. 3-5, according to an example implementation of the present disclosure.

FIG. 7 illustrates a block diagram of an energy harvesting node for wireless communication according to an example implementation of the present disclosure.

FIG. 8 illustrates a block diagram of a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B and/or C” should be interpreted to mean any of only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may be formed of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more BSs.

It should be noted that, in the present application, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a BS controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the DL and optionally the UL resources to at least one UE within its radio coverage for DL and optionally UL packet transmission). The BS may communicate with one or more UEs in the radio communication system through the cells.

A cell may allocate sidelink (SL) resources for supporting Proximity Service (ProSe) or V2X services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As discussed above, the frame structure for NR is to support flexible configurations for accommodating various next generation (e.g., 5G) communication requirements, such as Enhanced Mobile Broadband (eMBB), mMTC, Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access and may always be activated. Additionally, for a UE in an RRC_CONNECTED state that is not configured with the CA/DC, may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

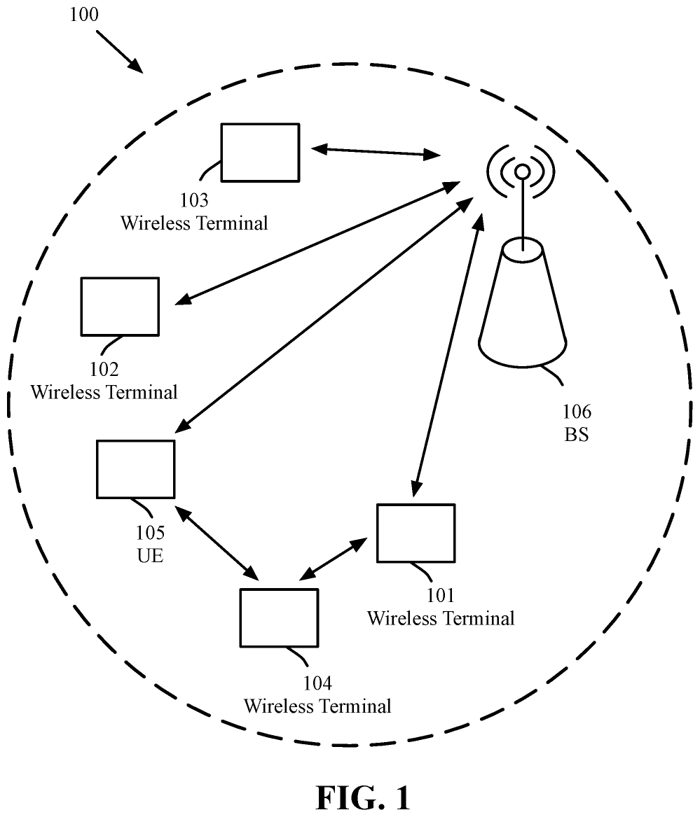

FIG. 1 is a schematic diagram illustrating a wireless communication system 100, according to an example implementation of the present disclosure. In FIG. 1, the wireless communication system 100 includes the wireless terminals 101-104, the UE 105, and the BS 106. The terms base station device, base station, and BS herein may be used interchangeably.

The BS 106 may communicate with one or more wireless terminals, such as wireless terminals 101-103 and the UE 105, through one or more cells. A cell is defined as a set of resources used for a wireless communication. A cell may include one or both of a downlink component carrier and an uplink component carrier. A downlink component carrier and an uplink component carrier may also be referred to as component carriers.

The wireless terminals 101-104 may be energy harvesting wireless terminals. Some of the energy harvesting wireless terminals may be of such limited capability that they may have minimal or no capacity to receive DL signals from the BS 106 (or transmit UL signals to the BS 106). In the example of FIG. 1, the wireless terminals 101-103 may be able to generate enough power, and/or may be in close vicinity of the BS 106, that may be able to communicate directly (e.g., though UL and/or DL signals) with the BS. The wireless terminal 104, on the other hand, may be able to directly communicate with the UE 105 or with another wireless terminal device 101 (e.g., through SL signals) without the participation of the BS 106 in the transmission and reception of data traffic.

The wireless terminals 101-104 may be AIoT devices that harvest energy from radio waves, solar, light, motion, vibration, heat, pressure, or any other power sources. The energy harvesting by a wireless terminal device may be continuous or incidental. It is also possible that the network controls when or where some forms of harvestable power, such as radio waves, are provided. An energy harvesting wireless terminal may not always have enough power to initiate or receive communication.

The operation of a battery-less energy harvesting wireless terminal (e.g., the activation and operation of the energy harvesting wireless terminal's microprocessor and other device components dependent upon the microprocessor's operation) may be dependent upon a harvestable energy source that is immediately available to the device and of a duration sufficient to power the device to the completion of its intended operational time frame.

An energy harvesting wireless terminal may have limited energy storage capability (e.g., a capacitor) in which case the operation of the device may be independent of an immediate availability and/or temporal harvestable energy source, and the device may store the harvested energy when available and use the stored energy as needed and as sufficient to power the device for a duration that is necessary to complete the device's intended operational time frame.

The energy harvesting wireless terminal may have low complexity, small size and lower capabilities and lower power consumption than previously defined 3GPP IoT devices (e.g., NB-IoT/enhanced Machine Type Communication (eMTC) devices). The energy harvesting wireless terminal may be maintenance free and may have long life span (e.g., more than 10 years). However, the life span of an energy harvesting wireless terminal may also be relatively short, such as, when tracking a package through a logistics chain.

The low complexity of an energy harvesting wireless terminal may be reflected in the energy harvesting wireless terminal's efficient use of 3GPP UL and DL time and frequency resources when communicating with a BS or when communicating with other devices capable of using 3GPP UL and DL time and frequency resources. The low complexity of an energy harvesting wireless terminal may be reflected in a BS's efficient use of 3GPP UL and DL time and frequency resources when communicating with an energy harvesting wireless terminal. The energy harvesting wireless terminals may have low data usage. Generally, energy harvesting wireless terminal data transmissions may contain only a few hundred bits of data.

As discussed above, such energy harvesting wireless terminals lead to new functional and performance requirements to a 5G system. Specifically, the energy harvesting wireless terminals use cases require new functional requirements, for example, communication aspects of energy harvesting wireless terminals and network, positioning of energy harvesting wireless terminals, management of energy harvesting wireless terminals, exposure of related network capabilities, of data collected by the energy harvesting wireless terminals and of information about the energy harvesting wireless terminals, charging, security, and privacy. The implementations provided in this disclosure discuss efficient communication mechanisms between such wireless terminals the require minimum power for signal transmission and/or reception.

### NR Frame Structure

The 5G NR Frame structure is described in the NR 3GPP standards (e.g., Technical Specification (TS) 38.211). The 5G NR frame structure includes subframes, slots, and symbol configurations. As described above, the 5G NR supports two frequency ranges: FR1 (which is under 7.125 gigahertz (GHz)) and FR2 (also known as millimeter wave range, which is between 24.25 GHz to 71.2 GHz). NR uses flexible subcarrier spacing derived from basic 15 kilohertz (kHz) subcarrier spacing that is also used in the LTE. A frame may have a duration of 10 milliseconds (ms) which may include 10 subframes each having 1 ms duration, which is similar to the LTE networks. Each subframe may have 2 slots (being a member of the set of [0.4]). Each slot may typically include 14 OFDM symbols. The number of symbols, however, may depend upon the start and length indicator value (SLIV). The radio frames of 10 ms may be transmitted continuously one after the other as per Time Division Duplex (TDD) or Frequency Division Duplex (FDD) topology. A subframe may be of a fixed duration (e.g., 1 ms) whereas a slot's length may vary based on a subcarrier spacing (SCS) and the number of slots per subframe. A slot is 1 ms for 15 kHz, 500 μs for 30 kHz, and so on. The subcarrier spacing of 15 kHz may occupy one slot per subframe, whereas the subcarrier spacing of 30 kHz may occupy two slots per subframe, and so on. Each slot may occupy either 14 OFDM symbols or 12 OFDM symbols, depending on the normal cyclic prefix (CP) or extended CP, respectively.

It should be noted that even though for the remainder of this disclosure, a 14-symbol configuration that is based on a normal CP is discussed, a 12-symbol configuration that is based on an extended CP may not be precluded from the solution space.

In 5G, a resource element (RE) is the smallest physical resource in NR which may include one subcarrier during one OFDM symbol. Also, in 5G, one NR Resource Block (RB) may contain 12 subcarriers in the frequency domain, irrespective of the numerology, and is defined only in the frequency domain (e.g., the bandwidth may not be fixed and may be dependent upon the configured subcarrier spacing). Additionally, in 5G, Physical Resource Blocks (PRBs) are the RBs that are used for actual/physical transmission/reception.

### NR Numerology

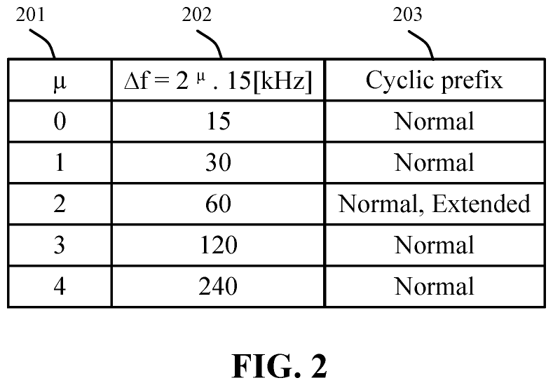

Numerology is a term used in the 3GPP specification to describe the different subcarrier spacing types. FIG. 2 is a diagram illustrating parameters related to subcarrier spacing (SCS), according to an example implementation of the present disclosure. The figure shows several different types of subcarrier spacing (which are similar to the Table 4.2-1 in TS 38.211) that defines the supported transmission numerologies. With reference to FIG. 2, Δf 202 is subcarrier spacing. The subcarrier spacing configuration μ 201 and the cyclic prefix 203 for a downlink or uplink bandwidth part may be obtained from the higher-layer parameters subcarrierSpacing and cyclicPrefix, respectively.

It should be noted that for the remainder of this disclosure, the terms numerology and SCS may be used interchangeably. It should also be noted that the term “SCS configuration factor n” may be used to refer to a subcarrier spacing type, where n may belong to the set [0, 1, 2, 3, 4], as noted in the table of FIG. 2 and is referred to as μ 201.

### Energy Harvesting Limitations of an AIoT Device

As identified by the 5GS, (e.g., by section 5.2.1 of TS22.369), communication between 5G network/Ambient IoT capable UE and Ambient IoT devices may include periodic sensor reporting or network-initiated inventory. The communication between an AIoT device and the network may be driven by events (e.g., mobile originated messaging) at the device or by events (e.g., mobile terminated messaging) at the BS (e.g., the gNB). In either case, it is not expected that there may be any coordination between the device originated messaging and the network originated messaging. Therefore, it may be assumed that the duration between any two-message traffic is nondeterministic.

It is expected that the period at which the network (or other device capable of transmitting/receiving AIoT communications) may attempt to communicate with an AIoT device maybe a function of the network's needs to access an AIoT device for the purposes such as, sending the device configuration data (e.g. data controlling the device's operation), sending the device user data (e.g., data controlling the operation of sensors on the device), acquiring from the device the device's operational data (e.g., device status data), or acquiring from the device the device's user data (e.g., sensor output data) or all of the above.

It is also expected that that the period at which an AIoT device may attempt to communicate with the network (or other device capable of transmitting/receiving AIoT communications) may be a function of at least two aspects related to the AIoT device's operation. The first aspect may be the AIoT device's need to access the network for the purposes of sending the device status data (e.g. data representing the device's operation), sending the device user data (e.g. data representing the operation of sensors on the device), acquiring from the network the device's operational data (e.g., device configuration data), or acquiring from the network the device's user data (e.g., sensor configuration data) or all of the above.

The second aspect may be that the AIoT device having sufficient energy available to operate its transmitter/receiver/processor for a certain period of time (e.g. one complete data object transmission) and at a certain transmitter power level, such as TxMin. Where TxMin is the minimum power at which a wireless terminal transmits a symbol such that a wireless terminal that receives the symbol may exceed a signal detection threshold for correctly decoding the symbol. It should be noted that the term “certain transmitter power level”, is used herein to indicate the output power level of the device's transmitter, when averaged over the duration of time and frequency resources used to transport a message output by the device.

As described above, the energy used to operate an AIoT device may be derived (e.g., harvested) from the environment in which the device is operating. As the environmentally derived energy source may be intermittent, and generally outside of the control of the AIoT device, the opportunities for the device to harvest energy from the environment is generally non-deterministic between any two-energy harvesting opportunities. As the duration of the environmentally derived energy source may be brief, the quantity of energy harvested may be minimal.

Therefore, for each brief and intermittent energy harvesting opportunity, the AIoT device may only be able to acquire a fraction of the energy necessary to facilitate the successful transmission of one complete data object at a certain transmitter power level. Therefore, to accumulate sufficient energy as necessary to facilitate the successful transmission of one complete data object at a certain transmitter power level, the AIoT device may store the harvested energy from each energy harvesting opportunity into an energy storing device such as a capacitor.

Once the AIoT device has stored sufficient energy in its capacitor to facilitate the transmission of one complete data object at a certain transmitter power level, the AIoT device may be capable of establishing a communication channel with a BS, such as a gNB, (e.g., to respond to requests from a gNB to establish communication or originate a communication with the gNB). However, such communications may result in the AIoT device using nearly all the energy available in the capacitor to accomplish the transmission of the at least one complete data object at a certain transmitter power level.

If the AIoT device were to use nearly all the energy available in the capacitor (e.g. after transmitting at least one complete data object at a certain transmitter power level), the AIoT device's reserve energy capacity maybe such that the AIoT device may not be able to transmit another data object at a certain transmitter power level until the energy stored in the capacitor is restored to a threshold that may be sufficient to facilitate a complete transmission of at least one data object at a certain transmitter power level.

Communication Sessions while AIoT Device has Insufficient Power to Successfully Communicate

As noted above, the time required to harvest sufficient energy to charge a capacitor to a certain threshold that may support a complete data object transmission at a certain transmitter power level is nondeterministic. As such, the time between at least two consecutive communications of a BS (e.g., a gNB) and an AIoT device is also nondeterministic if the energy level of the capacitor were to fall below a threshold that may be sufficient to facilitate a complete transmission of at least one data object at a certain transmitter power level following the transmission of a first data object.

A Communication Session that is Originated by a BS

During this nondeterministic period, the AIoT device may be re-charging its capacitor with each energy harvesting opportunity. However, if the AIoT device were to receive a communication, such as a request message, from the BS (e.g., a gNB) during this period of re-charging its capacitor, by attempting to receive the message and decoding the message, the device may use some of the energy stored in the capacitor to operate the device's receiver and processor to decode the request message from the BS.

In a first case, the energy level of the AIoT device's capacitor may be below a first threshold such that the device may not be able to fully operate the receiver to receive the request message nor operate the processor to decode the request message transmitted by the BS, nor be able to transmit a complete data object at a certain transmit power level in response to the request message from the BS. In this case, any energy used by the AIoT device in such an effort is wasted as the request message may not be correctly received by the device.

In a second case, the energy level of the capacitor may be above the first threshold but below a second threshold such that the device may be able to fully operate the receiver to receive the request message but may not be able to operate the processor to decode the request message transmitted by the BS, nor may it be able to transmit a complete data object at a certain transmit power level in response to the request message from the BS. In this case, any energy used by the AIoT device in such an effort is wasted as the request message may not be decoded by the device.

In a third case, the energy level of the capacitor may be above the second threshold but below a third threshold such that the device may be able to fully operate the receiver to receive the request message and operate the processor to decode the request message transmitted by the BS, but may not be able to transmit a complete data object at a certain transmit power level in response to a request message from the BS. In this case, any energy used by the AIoT device in such an effort is wasted as the AIoT device's response message to the request message may not be fully received by the BS.

A Communication Session that is Originated by the Device

During this nondeterministic period, the AIoT device may be re-charging its capacitor with each energy harvesting opportunity. However, if the AIoT device were to transmit a request message to the BS during this period of re-charging its capacitor and attempt to encode the message and transmit the message, the device may use some of the energy stored in the capacitor to operate its processor to encode the request message and transmit the request message to the AIoT.

In a first case, the energy level of the capacitor may be below a first threshold such that the device may not be able to operate the processor to encode the request message to the AIoT nor fully operate the transmitter to transmit the request message to the BS. In this case, any energy used by the AIoT device in such an effort is wasted as the request message cannot be acted upon by the BS.

In a second case, the energy level of the AIoT device's capacitor may be above the first threshold but below a second threshold such that the device may be able to operate the processor to encode the request message for transmission to the BS, but may not be able to fully operate its transmitter to transmit a complete data object at a certain transmit power level. In this case, any energy used by the AIoT device is such an effort is wasted as the AIoT device's request message to the BS may not be fully received by the BS.

Therefore, as described below, some embodiments may provide an indication, such as a bit that is included in the last transmission by the AIoT device. The bit may be encoded to indicate to the BS that the device has either sufficient energy resources to receive a command and transmit a data object, or it does not have sufficient energy resources to receive a command and transmit a data object.

### Providing an Indication of the Remaining Power of an AIoT Device

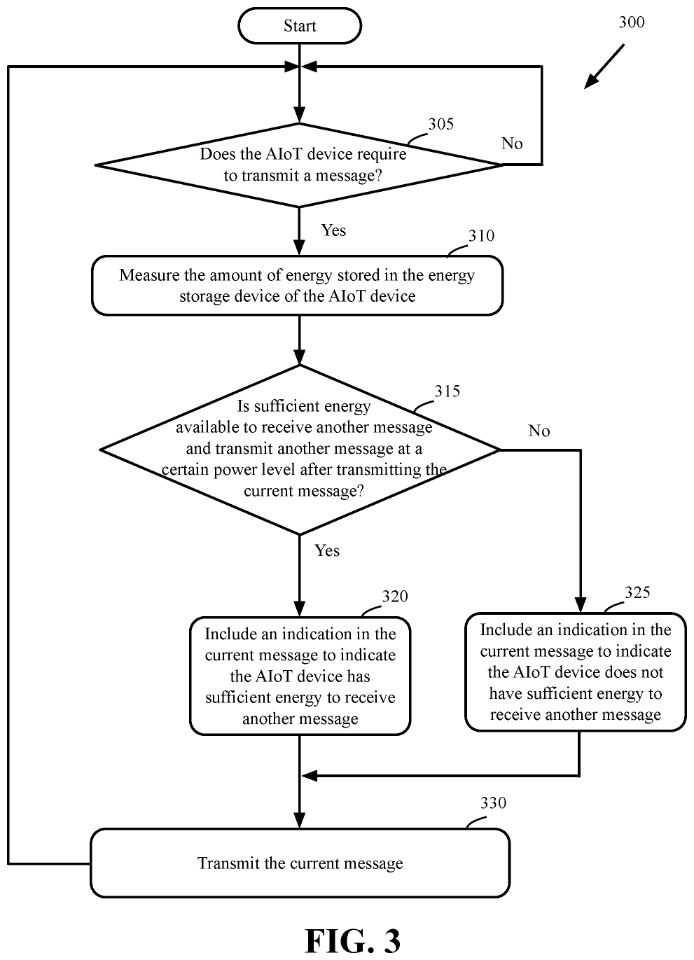

FIG. 3 illustrates a flowchart of an example method/process 300 performed by an AIoT device to transmit an indication of whether the AIoT device has sufficient power to transmit or receive another message, according to an example implementation of the present disclosure. With reference to FIG. 3, the process 300 may be performed by at least one processor of any of the AIoT wireless terminals 101-104 of FIG. 1.

At block 305, a determination may be made as to whether the AIoT wireless terminal requires to transmit a message. For example, the AIoT device may have received a message from the BS 106 or the UE 105 of FIG. 1 that may require a response by the AIoT device. As another example, the AIoT device may have a status message to transmit or may have to transmit a request for information from the BS 106 or the UE 105.

When the AIoT wireless terminal does not require to transmit a message, the process 300 may proceed back to block 305. Otherwise, the amount of energy stored in the power storage device of the AIoT device may be measured (at block 310). For example, the processor of the AIoT device may measure the energy level stored in an energy storage capacitor of the AIoT device.

As a nonlimiting example, some embodiments may use a Coulomb counter for measuring the amount of energy stored in the power storage device of the AIoT device. A Coulomb counter may operate by measuring the current flow in a circuit, either continuously or at discrete intervals, and integrating it over time. This integration process may calculate the total charge (in Coulombs) that has passed through the circuit. The Coulomb counter may include a circuitry that outputs a bit value that the processor of the AIoT device may read to determine the level of charge held by the capacitor.

A determination may be made (at block 315) as to whether sufficient energy is available for the AIoT device to receive another message and transmit another message at a certain power level after transmitting the current message. In some embodiments, the AIoT device may be configured at the time of manufacturing or by an RRC reconfiguration with a certain reception and transmission power level. In some embodiments, the AIoT device may store the power level required for reception as a first power-level parameter and the power level required for transmission as a second power-level parameter. These thresholds may be compared with the energy stored in the energy storage device of the AIoT device to determine whether enough power is available for future receptions and transmissions.

If sufficient energy is available for the AIoT device to receive another message and transmit another message after transmitting the current message, an indication may be included (at block 320) in the current message to indicate the AIoT device has sufficient energy to receive another message. The process 300 may then proceed to block 330, which is described below.

The AIoT device, in some embodiments, may use a single logical bit to encode the indication that following the transmission of the current data object the AIoT device does or does not have sufficient energy resources to receive a subsequent command and/or transmit a subsequent data object. The single logical bit encoding may be used to indicate the AIoT device does or does not have sufficient energy resources to receive a subsequent command and/or transmit a data object subsequent to the received command. For example, the state of the single logical bit set (at block 320) to logical one may be understood by a receiving BS as an indication that the AIoT device does have sufficient energy resources to receive a subsequent command and/or transmit a data object subsequent to the command.

If the available energy is insufficient to receive another message and transmit another message after transmitting the current message, an indication may be included (at block 325) in the current message to indicate the AIoT device does not have sufficient energy to receive another message and/or transmit another message.

For example, in the embodiments that use a single logical bit to indicate whether or not the AIoT device does or does not have sufficient energy resources, the state of the single logical bit set to logical zero (at block 325) may be understood by a receiving BS as an indication that the AIoT device does not have sufficient energy resources to receive a subsequent command and/or transmit a data object subsequent to the command. In some embodiments, the receiving BS (or a UE such as the UE 105 of FIG. 1) which is communicating with the AIoT device may avoid communicating with the AIoT device for a threshold period of time to allow the AIoT device to harvest and store energy from the environment. At block 330, the current message may be transmitted. The process 300 may then proceed back to block 305, which was described above.

It should be noted that the logical state of the single bit that is used to encode the indication that following the transmission of the current data object the AIoT device does not have sufficient energy resources to receive a subsequent command and/or transmit a subsequent data object may be defined such that its physical state is represented as a low energy modulation condition at the transmitter (e.g., a low energy modulation state indicating that the AIoT device does not have sufficient energy resources). As an example, Quadrature Amplitude Modulation (QAM) is a digital modulation scheme where data is transmitted over a channel by varying both the amplitude and phase of the high-frequency carrier signal. The transmitted signal may be represented in a constellation plot that contains two axes namely the in-phase and Quadrature. The in-phase and Quadrature axes may be separated from each other by a phase of 90°. Therefore, these two axes are orthogonal to each other.

In the QAM scheme, two or more bits may be grouped together to form a symbol that lies in the constellation plot. Each symbol, also called state, may have a unique amplitude and phase level that provides distinction across different points in the constellation. As noted above, the encoded bits of a QAM group may be represented by an amplitude and phase, thus some of the groups may have lower amplitude than other groups. These group, therefore, may require less transmission power.

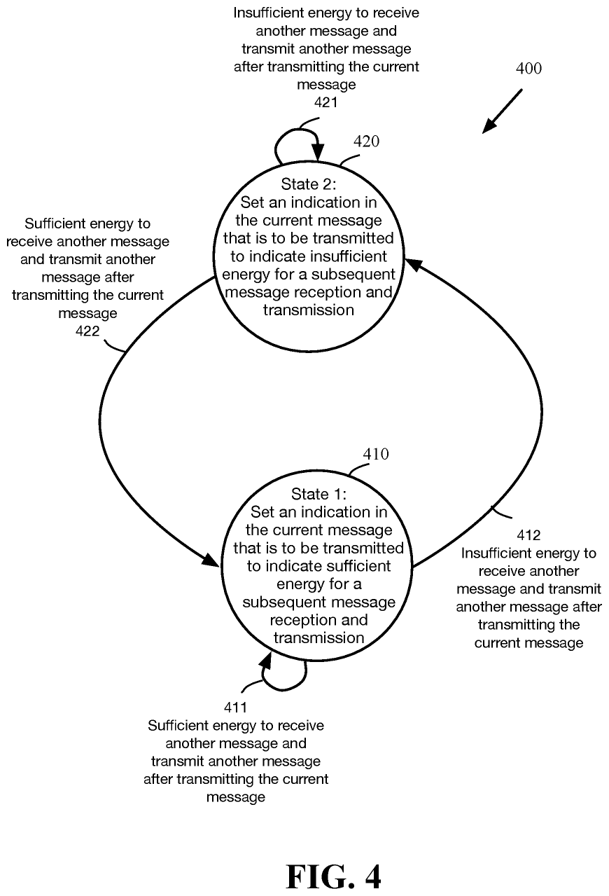

FIG. 4 is a state diagram 400 of an AIoT device for indicating whether the AIoT device has sufficient energy for subsequent message reception and transmission, according to an example implementation of the present disclosure. As shown, in the first state 410, an indication is set in the current message that is to be transmitted to indicate sufficient energy for a subsequent message reception and transmission. For example, the AIoT device may be in the state 410 after the process 300 of FIG. 3 determines (at block 315) that sufficient energy is available for the AIoT device to receive another message and transmit another message at a certain power level after transmitting the current message.

As long as the AIoT device has sufficient energy to receive another message and transmit another message at a certain power level after transmitting a current message, the AIoT device may remain (as shown by the arrow 411) in the state 410 and may receive and transmit messages.

The AIoT device may transition (as shown by the arrow 412) from the first state 410 to the second state 420 when there is insufficient energy to receive another message and transmit another message after transmitting the current message. In the state 420, an indication may be set in the current message that is to be transmitted to indicate insufficient energy for a subsequent message reception and transmission. For example, the AIoT device may be in the state 420 after the process 300 of FIG. 3 determines (at block 315) that insufficient energy is available for the AIoT device to receive another message and transmit another message at a certain power level after transmitting the current message.

As long as the AIoT device has insufficient energy to receive another message and transmit another message at a certain power level after transmitting a current message, the AIoT device may remain (as shown by the arrow 421) in the state 420 and may fail to receive and/or transmit messages. The AIoT device may transition (as shown by the arrow 422) from the second state 420 to the first state 410 when there is sufficient energy to receive another message and transmit another message after transmitting the current message. For example, the AIoT device may transition from the second state 420 to the first state 410 when the AIoT device has harvested the sufficient amount of energy from the environment and has stored the energy in the AIoT device's capacitor.

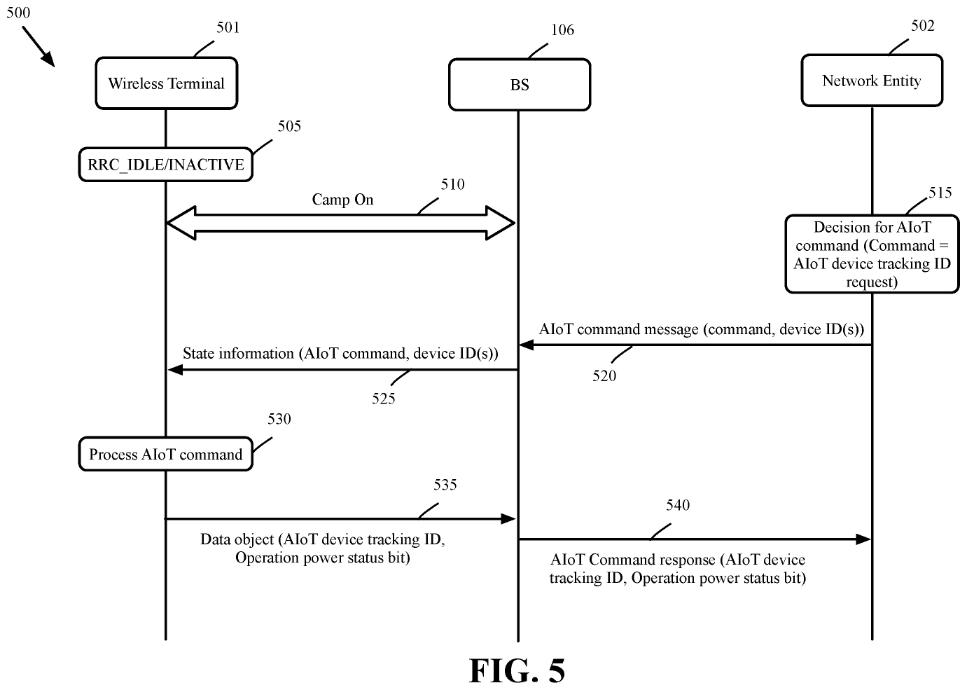

FIG. 5 is a sequence diagram 500 illustrating an example message flow for a wireless terminal to transmit an indication as to whether or not the AIoT device has sufficient energy for subsequent reception and transmission of messages, according to an example implementation of the present disclosure. With reference to FIG. 5, the commands, herein also referred to as configuration change commands, may impact the first and second power-level parameters described above with reference to FIG. 3. The commands may be transmitted by a BS (e.g., a gNB) or other authorized transmission device (e.g., the UE 105 of FIG. 1) in one or more of multiple signaling methods. Such multiple signaling methods may include system information broadcast and dedicated signaling.

With further reference to FIG. 5, the wireless terminal 501 may be one of the energy harvesting wireless terminals 102-104 of FIG. 1. In the example of FIG. 5, a network entity 502 may decide to send an AIoT command to the wireless terminal 501.

In one configuration, the network entity 502 may be a network node such as a server or a node in a core network, such as an Access and Mobility Management Function (AMF). In another configuration, the network entity 502 may be a server resident in a private/public network. The BS 106 may be similar to the BS 106 of FIG. 1. The BS 106, in some implementation, may be a gNB.

At block 505, the wireless terminal 501 may be in RRC_IDLE or RRC_INACTIVE state. As shown in step 510, the wireless terminal 501 may be camping on a cell served by the BS 106. At block 515, the network entity may decide to request the AIoT device 501 to report its device tracking identification (tracking ID). It should be noted that the device's tracking ID, which may be used, for example, and without limitations, to track an inventory item to which the AIoT device is attached may or may not be the same as the AIoT device's ID. In some embodiments, the AIoT devices may include a serial number in their non-volatile memory. The serial number may be unique among all potentially constructed AIoT devices.

In step 520, the network entity 502 may send the AIoT command message that may include one or more commands (e.g., a command requesting the AIoT device to report the AIoT device's tracking ID). The one or more commands may be associated with one or more device IDs, including the ID of the AIoT device 501. Additionally, or alternatively, the AIoT command message may include one or more device group IDs, each of the device group ID may identify a group of devices.

In step 525, the BS 106 may broadcast the contents of the AIoT command message in system information, such as one or more System Information Blocks (SIBs). In block 530, the AIoT device 501 may receive the system information broadcast and may check if the device ID of the wireless terminal 501 is included. If so, the AIoT device 501 may execute the command to transmit the AIoT deice tracking ID as instructed by the received command received in step 525.

In response to the processing of step 530, the AIoT device 501 may send (in step 535) a response message (also referred to as a data object) to the BS 106 that includes the AIoT device's tracking ID as commanded by Bs 106 in step 525. The response message may include the logical bit described above with reference to FIG. 3 as an Operating Power Status Bit. In step 540, the BS 106 may forward the content of the data object message to the network entity 502.

It should be noted that the message sent from the network entity (in step 520) and/or the message sent by the BS 106 (in step 525) may be a configuration message to change the receive or transmit power-level parameters of the AIoT device, causing the AIoT device to require a different power threshold to receive or transmit messages. In some embodiments, the receive or transmit power-level parameters of the AIoT device may be configured to the AIoT device at the manufacturing time. In some embodiments, these parameters may be changed by a network entity (e.g., the network entity 502) and/or by a BS (e.g., by the BS 106) by a messaging sequence similar to the messaging sequence of FIG. 5.

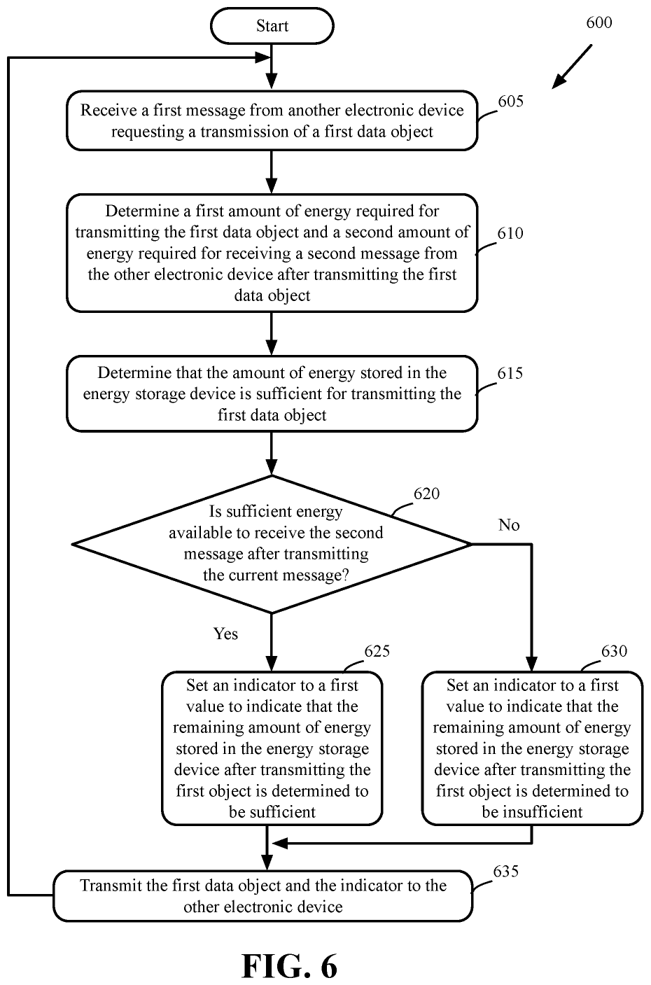

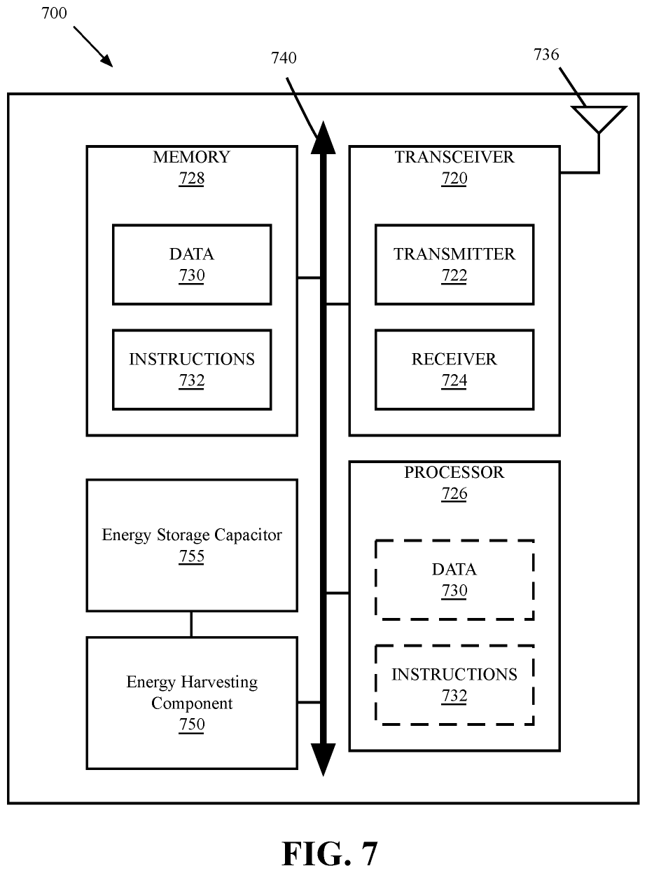

FIG. 6 is a flowchart illustrating an example method/process 600 performed by a wireless terminal implementing the embodiments of FIGS. 3-5, according to an example implementation of the present disclosure. With reference to FIG. 6, the process 600 may be performed by at least one processor of any of the AIoT wireless terminals 101-104 of FIG. 1. The AIoT wireless terminal may include an energy harvesting component and an energy storage capacitor, as described below with reference to FIG. 7.

At block 605, a first message may be received from another electronic device requesting a transmission of a first data object. For example, as described above with reference to FIG. 5, an AIoT command message may be sent by a network entity 502 and the AIoT command message may be received (in step 525 of FIG. 5) by the AIoT device 501 through a state information message that is received from the BS 106. In some embodiments, the AIoT command message may be received by the AIoT device from a UE, such as the UE 105 of FIG. 1. The first data object may, for example, be the tracking ID of the AIoT device.

A first amount of energy required for transmitting the first data object and a second amount of energy required for receiving a second message from the other electronic device after transmitting the first data object may be determined (at block 610). As described above, the AIoT device may be configured at manufacturing time with first and second parameters to indicate the energy level required to receive or transmit messages. The first and second parameters may also be configured into the AIoT device, for example, by RRC messages sent by a BS or another network entity.

At block 615, it may be determined that the amount of energy stored in the energy storage device is sufficient for transmitting the first data object. For example, the processor of the AIoT device may compare the remaining energy in the energy storage capacitor of the AIoT device with the first amount of energy determined at block 610 and may determine (at block 615) that the amount of energy stored in the energy storage device is sufficient for transmitting the first data object.

A determination may be made (at block 620) as to whether sufficient energy is available to receive the second message after transmitting the current message. For example, the processor of the AIoT device may calculate the remaining energy in the energy storage capacitor after the transmission of the first data object. The processor of the AIoT device may then compare the remaining energy in the energy storage capacitor after the transmission of the first data object with the second amount of energy determined at block 610.

In a case that sufficient energy is available to receive the second message after transmitting the current message, an indicator may be set (at block 625) to a first value to indicate that the remaining amount of energy stored in the energy storage device after transmitting the first object is determined to be sufficient. In some embodiments, the indicator may be a logical bit. In these embodiments, the first value may be one of 1 and 0, and a second value, indicating insufficient energy, may be the other one of 1 and 0. The process 600 may then proceed to block 635, which is described below.

The logical bit, in some embodiments, may be in a data structure, such as the information element (IE) shown in Table 1, below. The logical bit may, for example, be the optional Boolean “inSufficientEnergyReceiveAnotherMessag-r18” parameter of Table 1. The data structure (e.g., the IE of Table 1 that includes the logical bit) may be sent from the network's upper layer along with the first data object (that may include the requested data, such as, the tracking ID of the AIoT device) to the network's lower layers (e.g., the physical layer). The lower layers may then encode the IE and the first data object to the transport layer. The transport layer may then send the results as one data object to the receiving device (e.g., the BS 106 of FIG. 5).

In a case that sufficient energy is not available to receive the second message after transmitting the current message, the indicator may be set (at block 630) to a second value to indicate that the remaining amount of energy stored in the energy storage device after transmitting the first object is determined to be insufficient. For example, the logical bit described above may be set to a value that indicates insufficient stored energy.

At block 635, the first data object and the indicator may be transmitted to the other device. For example, as described above with reference to steps 535 and 540 of FIG. 5, the AIoT device 501 may transmit the first data object and the indicator to the network. The process 600 may then proceed to block 605, which was described above.

In some embodiment, a third amount of energy for transmitting a second data object in response to receiving the second message may be determined (at block 610). Based on the third amount of energy, a determination may be made as to whether a second remaining amount of energy stored in the energy storage device after receiving the second message is sufficient for transmitting the second data object. In these embodiments, setting the indicator to the second value further includes setting the indicator to the second value in a case that the second remaining amount of energy stored in the energy storage device after receiving the second message is determined to be insufficient.

In some scenarios, the AIoT device may attempt to communicate with the network. For example, the AIoT device may need to access the network for the purposes of sending the device status data (e.g. data representing the AIoT device's operation). The AIoT device may need to send the device user data (e.g. data representing the operation of sensors on the device). The AIoT device may need to acquire the device's operational data (e.g., device configuration data) from the network. The AIoT device may need to acquire the device's user data (e.g., sensor configuration data) from the network. In such scenarios, the AIoT device may initiate the communication with the network without receiving a request message or a command from the network. In these scenarios, block 605 of process 600 may be skipped and the first data object may be the data object that the AIoT device needs to send to the network.

### UE Assistance Information Element

The UEAssistanceInformation message that is used for the indication of UE assistance information to the network is described below in Tables 1 and 2. The signalling radio bearer are signalling radio bearer 1 (SRB1) and signalling radio bearer 3 (SRB3). The radio link control service access point (RLC-SAP) is acknowledge mode (AM). The logical channel is Downlink Control Channel (DCCH). The direction of the message is from the wireless terminal (e.g., the AIoT device 501 of FIG. 5) to the network (e.g., to the BS 106 and/or the network entity 502 of FIG. 5).

TABLE 1
UEAssistanceInformation message

-- ASN1START
-- TAG-UEASSISTANCEINFORMATION-START

| | |
|---|---|
| UEAssistanceInformation ::= | SEQUENCE { |

| | |
|---|---|
| criticalExtensions | CHOICE { |

| | |
|---|---|
| ueAssistanceInformation | UEAssistanceInformation-IEs, |

| | |
|---|---|
| criticalExtensionsFuture | SEQUENCE { } |

}
}

| | |
|---|---|
| UEAssistanceInformation-IEs ::= | SEQUENCE { |

| | | |
|---|---|---|
| delayBudgetReport | DelayBudgetReport | OPTIONAL, |

| | | |
|---|---|---|
| lateNonCriticalExtension | OCTET STRING | OPTIONAL, |

| | | |
|---|---|---|
| nonCriticalExtension | UEAssistanceInformation-v1540-IEs | OPTIONAL |

}
UEAssistanceInformation-v1540-IEs ::= SEQUENCE {

| | | |
|---|---|---|
| overheatingAssistance | OverheatingAssistance | OPTIONAL, |

| | | |
|---|---|---|
| nonCriticalExtension | UEAssistanceInformation-v1610-IEs | OPTIONAL |

}
UEAssistanceInformation-v1610-IEs ::= SEQUENCE {

| | | |
|---|---|---|
| idc-Assistance-r16 | IDC-Assistance-r16 | OPTIONAL, |
| drx-Preference-r16 | DRX-Preference-r16 | OPTIONAL, |

| | | |
|---|---|---|
| maxBW-Preference-r16 | MaxBW-Preference-r16 | OPTIONAL, |
| maxCC-Preference-r16 | MaxCC-Preference-r16 | OPTIONAL, |

| | | |
|---|---|---|
| maxMIMO-LayerPreference-r16 | MaxMIMO-LayerPreference-r16 | OPTIONAL, |
| minSchedulingOffsetPreference-r16 | MinSchedulingOffsetPreference-r16 | OPTIONAL, |

| | | |
|---|---|---|
| releasePreference-r16 | ReleasePreference-r16 | OPTIONAL, |

| | | |
|---|---|---|
| sl-UE-AssistanceInformationNR-r16 | SL-UE-AssistanceInformationNR-r16 | OPTIONAL, |

| | | |
|---|---|---|
| referenceTimeInfoPreference-r16 | BOOLEAN | OPTIONAL, |

| | | |
|---|---|---|
| nonCriticalExtension | UEAssistanceInformation-v1700-IEs | OPTIONAL |

}
UEAssistanceInformation-v1700-IEs ::= SEQUENCE {

| | | |
|---|---|---|
| ul-GapFR2-Preference-r17 | UL-GapFR2-Preference-r17 | OPTIONAL, |

| | | |
|---|---|---|
| musim-Assistance-r17 | MUSIM-Assistance-r17 | OPTIONAL, |
| overheatingAssistance-r17 | OverheatingAssistance-r17 | OPTIONAL, |

| | | |
|---|---|---|
| maxBW-PreferenceFR2-2-r17 | MaxBW-PreferenceFR2-2-r17 | OPTIONAL, |

| | | |
|---|---|---|
| maxMIMO-LayerPreferenceFR2-2-r17 | MaxMIMO-LayerPreferenceFR2-2-r17 | OPTIONAL, |
| minSchedulingOffsetPreferenceExt-r17 | MinSchedulingOffsetPreferenceExt-r17 | OPTIONAL, |

| | | |
|---|---|---|
| rlm-MeasRelaxationState-r17 | BOOLEAN | OPTIONAL, |

| | | |
|---|---|---|
| bfd-MeasRelaxationState-r17 | BIT STRING (SIZE (1..maxNrofServingCells)) | OPTIONAL, |

| | |
|---|---|
| nonSDT-DataIndication-r17 | SEQUENCE { |

| | | |
|---|---|---|
| resumeCause-r17 | ResumeCause | OPTIONAL |

| | |
|---|---|
| } | OPTIONAL, |

| | |
|---|---|
| scg-DeactivationPreference-r17 | ENUMERATED { scgDeactivationPreferred, |

noPreference } OPTIONAL,

| | | |
|---|---|---|
| uplinkData-r17 | ENUMERATED { true } | OPTIONAL, |

| | | |
|---|---|---|
| rrm-MeasRelaxationFulfilment-r17 | BOOLEAN | OPTIONAL, |

| | | |
|---|---|---|
| propagationDelayDifference-r17 | PropagationDelayDifference-r17 | OPTIONAL, |

| | | |
|---|---|---|
| nonCriticalExtension | UEAssistanceInformation-v1800-IEs | OPTIONAL |

}
UEAssistanceInformation-v1800-IEs ::= SEQUENCE {

| | | |
|---|---|---|
| inSufficientEnergyReceiveAnotherMessag-r18 | BOOLEAN | OPTIONAL, |

| | | |
|---|---|---|
| nonCriticalExtension | SEQUENCE { } | OPTIONAL |

}
///Note other elements of this IE are removed for brevity //////
-- TAG-UEASSISTANCEINFORMATION-STOP
-- ASN1STOP

TABLE 2
UEAssistanceInformation field descriptions

inSufficientEnergyReceiveAnotherMessag
Indicates that the device does not yet have sufficient energy in its energy
storage device to receive and transmit a message.

FIG. 7 illustrates a block diagram of an energy harvesting node for wireless communication according to an example implementation of the present disclosure. The node 700 may, for example, be an AIoT, such as the wireless terminals 101-104 of FIG. 1.

As shown in FIG. 7, the node 700 may include transceiver 720, processor 726, memory 728, at least one antenna 736, an energy harvesting component 750, and an energy storage capacitor 755. The node 700 may also include an RF spectrum band module, a base station communications module, a network communications module, and a system communications management module, input/output (I/O) ports, I/O components, and power supply (not explicitly shown in FIG. 7). Each of these components may be in communication with each other, directly or indirectly, over one or more buses 740.

The transceiver 720 having the transmitter 722 and the receiver 724 may be configured to transmit and/or receive time and/or frequency resource partitioning information. In some implementations, the transceiver 720 may be configured to transmit in different types of subframes and slots including, but not limited to, usable, non-usable, and flexibly usable subframes and slot formats. The transceiver 720 may be configured to receive data and control signaling.

The node 700 may include a variety of computer-readable media. Computer-readable media may be any available media that may be accessed by node 700 and include both volatile and non-volatile media, removable and non-removable media. By way of example, and not limitation, computer-readable media may include computer storage media and communication media. Computer storage media may include both volatile and non-volatile, removable and non-removable media implemented in any method or technology for storage of information, such as computer-readable instructions, data structures, program modules, or other data.

Computer storage media include RAM, ROM, EEPROM, flash memory, or other memory technology, such as optical disk storage, magnetic cassettes, magnetic tape, magnetic disk storage, or other magnetic storage devices. Computer storage media do not include a propagated data signal. Communication media typically embody computer-readable instructions, data structures, program modules, or other data in a modulated data signal, such as a carrier wave, or other transport mechanism and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

The memory 728 may include computer-storage media in the form of volatile and/or non-volatile memory. The memory 728 may be removable, non-removable, or a combination thereof. Exemplary memory includes solid-state memory, hard drives, optical-disc drives, etc. As illustrated in FIG. 7, the memory 728 may store computer-readable, computer-executable instructions 732 (e.g., software codes) that are configured to, when executed, cause the processor 726 to perform various functions described herein, for example, some of the function described with reference to FIGS. 1 through 6. Alternatively, the instructions 732 may not be directly executable by processor 726 but be configured to cause the node 700 (e.g., when compiled and executed) to perform various functions described herein.

The processor 726 may include an intelligent hardware device, for example, a central processing unit (CPU), a microcontroller, an ASIC, etc. The processor 726 may include memory. The processor 726 may process data 730 and instructions 732 received from the memory 728, and information through the transceiver 720, the baseband communications module, and/or the network communications module. The processor 726 may also process information to be sent to the transceiver 720 for transmission through the antenna 736, to the network communications module for transmission to a core network.

The node 700 may include an energy harvesting component 750, which may be configured to harvest energy from the environment. The node 700 may use the energy harvested from the environment in lieu of a dedicated internal power source, such as a battery. The energy harvesting component 750 may be configured to harvest energy from one or more sources, such as, radio waves, solar, light, motion, vibration, heat, pressure, etc. For example, energy harvesting component 750 may include a radio wave antenna (which may be the same as the antenna 736 or may be a different antenna) to receive radio waves from the environment and to harvest energy from the received radio waves. As another example, the energy harvesting component 750 may include one or more solar cells to harvest solar energy or harvest energy from the ambient light. As another example, the energy harvesting component 750 may include one or more transducers to generate energy from motion, vibration, heat, pressure, etc.

The node 700 may include one or more energy storage units, such as the energy storage capacitor 755, to store energy harvested by the energy harvesting component 750. The processor 726 may be configured to determine the level of energy stored in the energy storage capacitor 755.

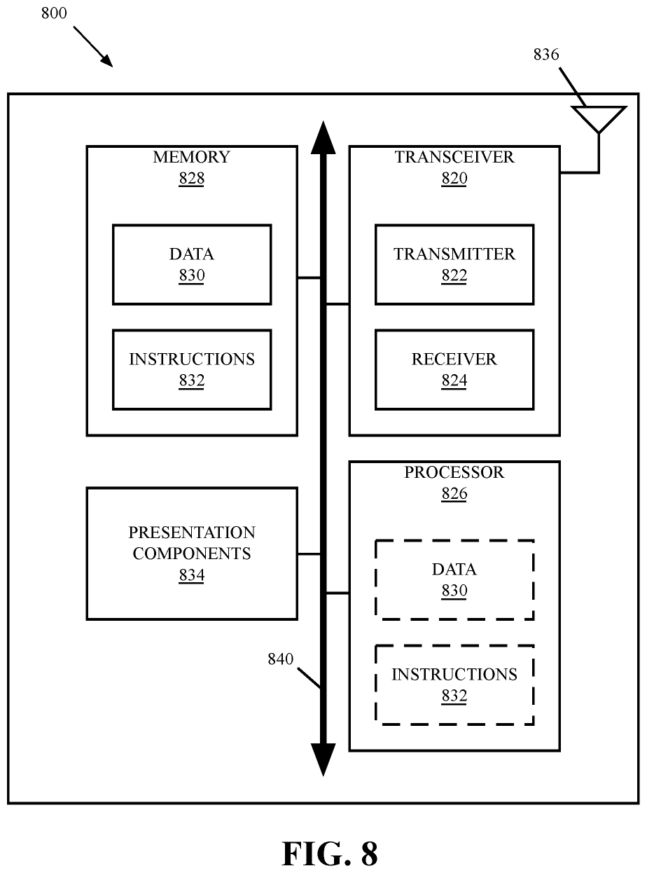

FIG. 8 illustrates a block diagram of a node for wireless communication according to an example implementation of the present disclosure. The node 800 may, for example, be a UE, such as the UE 105 of FIG. 1. As shown in FIG. 8, the node 800 may include transceiver 820, processor 826, memory 828, one or more presentation components 834, and at least one antenna 836. The node 800 may also include an RF spectrum band module, a base station communications module, a network communications module, and a system communications management module, input/output (I/O) ports, I/O components, and power supply (not explicitly shown in FIG. 8). Each of these components may be in communication with each other, directly or indirectly, over one or more buses 840.

The transceiver 820 having the transmitter 822 and the receiver 824 may be configured to transmit and/or receive time and/or frequency resource partitioning information. In some implementations, the transceiver 820 may be configured to transmit in different types of subframes and slots including, but not limited to, usable, non-usable, and flexibly usable subframes and slot formats. The transceiver 820 may be configured to receive data and control signaling.

The node 800 may include a variety of computer-readable media. Computer-readable media may be any available media that may be accessed by the node 800 and include both volatile and non-volatile media, removable and non-removable media. By way of example, and not limitation, computer-readable media may include computer storage media and communication media. Computer storage media may include both volatile and non-volatile, removable and non-removable media implemented in any method or technology for storage of information, such as computer-readable instructions, data structures, program modules, or other data.

Computer storage media include RAM, ROM, EEPROM, flash memory, or other memory technology, CD-ROM, digital versatile disks (DVD), or other optical disk storage, magnetic cassettes, magnetic tape, magnetic disk storage, or other magnetic storage devices. Computer storage media do not include a propagated data signal. Communication media typically embody computer-readable instructions, data structures, program modules, or other data in a modulated data signal, such as a carrier wave, or other transport mechanism and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

The memory 828 may include computer-storage media in the form of volatile and/or non-volatile memory. The memory 828 may be removable, non-removable, or a combination thereof. Exemplary memory includes solid-state memory, hard drives, optical-disc drives, etc. As illustrated in FIG. 8, the memory 828 may store computer-readable, computer-executable instructions 832 (e.g., software codes) that are configured to, when executed, cause the processor 826 to perform various functions described herein, for example, some of the function described with reference to FIGS. 1 through 6. Alternatively, the instructions 832 may not be directly executable by processor 826 but be configured to cause the node 800 (e.g., when compiled and executed) to perform various functions described herein.

The processor 826 may include an intelligent hardware device, for example, a central processing unit (CPU), a microcontroller, an ASIC, etc. The processor 826 may include memory. The processor 826 may process data 830 and instructions 832 received from the memory 828, and information through the transceiver 820, the baseband communications module, and/or the network communications module. The processor 826 may also process information to be sent to the transceiver 820 for transmission through the antenna 836, to the network communications module for transmission to a core network.

One or more presentation components 834 may present data indications to a person or other device. For example, one or more presentation components 834 include a display device, speaker, printing component, vibrating component, etc.

From the above description, it is manifest that various techniques can be used for implementing the concepts described in the present application without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. An energy harvesting electronic device, comprising:
an energy storage device configured to store energy harvested by the electronic device;
one or more non-transitory computer-readable media storing one or more computer-executable instructions; and
at least one processor coupled to the one or more non-transitory computer-readable media, and configured to execute the one or more computer-executable instructions to cause the electronic device to:
receive a first message from another electronic device requesting a transmission of a first data object;
determine a first amount of energy required for transmitting the first data object and a second amount of energy required for receiving a second message from the other electronic device after transmitting the first data object; and
after determining that, based on the first amount of energy, an amount of energy stored in the energy storage device is sufficient for transmitting the first data object:
determine, based on the second amount of energy, whether a remaining amount of energy stored in the energy storage device after transmitting the first object is sufficient for receiving the second message;
set an indicator to a first value in a case that the remaining amount of energy stored in the energy storage device after transmitting the first object is determined to be sufficient;
set the indicator to a second value in a case that the remaining amount of energy stored in the energy storage device after transmitting the first object is determined to be insufficient; and
transmit the first data object and the indicator to the other electronic device.

2. The electronic device of claim 1, wherein the remaining amount of energy stored in the energy storage device after transmitting the first object is a first remaining amount of energy stored in the energy storage device, wherein the at least one processor is further configured to execute the one or more computer-executable instructions to cause the electronic device to:
determine a third amount of energy for transmitting a second data object in response to receiving the second message; and
determine, based on the third amount of energy, whether a second remaining amount of energy stored in the energy storage device after receiving the second message is sufficient for transmitting the second data object, wherein setting the indicator to the second value further comprises setting the indicator to the second value in a case that the second remaining amount of energy stored in the energy storage device after receiving the second message is determined to be insufficient.

3. The electronic device, of claim 1, wherein the other electronic device is one of a base station (BS) and a user equipment (UE).

4. The electronic device, of claim 1, wherein the other electronic device is configured not to transmit any messages to the energy harvesting electronic device for a threshold amount of time in a case that the indicator received from the energy harvesting device is set to the second value.

5. The electronic device, of claim 1, wherein:
the indicator is a logical bit,
the first value is one of 1 and 0, and
the second value is the other one of 1 and 0.

6. The electronic device of claim 1, wherein:
a first parameter indicating a power required for transmitting first data and a second parameter indicating a power required for receiving second data are configured to the electronic device,
determining the first amount of energy comprises determining the first amount of energy based on the first parameter, and
determining the second amount of energy comprises determining the second amount of energy based on the second parameter.

7. The electronic device of claim 6, wherein the first and second parameters are configured to the electronic device at a time of manufacturing the electronic device.

8. The electronic device of claim 6, wherein the at least one processor is further configured to execute the one or more computer-executable instructions to cause the electronic device to:
receive a configuration message comprising one or more updated values for at least one of the first and second parameter; and
reconfigure at least one of the first and second parameters with the one or more updated values.

9. The electronic device of claim 8, wherein receiving the configuration message comprises receiving the configuration message via radio resource control (RRC) signaling.

10. The electronic device of claim 1, wherein the first data object comprises a tracking identification of the electronic device.

11. The electronic device of claim 10, wherein the first message requesting the transmission of the tracking identification of the electronic device comprises a request message broadcast by the other electronic device.

12. The electronic device of claim 11, wherein the request message broadcast by the other electronic device comprises one of a device identification or a device group identification of the electronic device.

13. The electronic device of claim 1, wherein the energy storage device comprises a capacitor.

14. The electronic device of claim 1, wherein the electronic device is an ambient Internet of things (AIoT) device.

15. A method, comprising:
receiving a first message at an energy harvesting electronic device from another electronic device requesting a transmission of a first data object, the energy harvesting electronic device comprising an energy storage device;
determining a first amount of energy required for transmitting the first data object and a second amount of energy required for receiving a second message from the other electronic device after transmitting the first data object; and
after determining that, based on the first amount of energy, an amount of energy stored in the energy storage device is sufficient for transmitting the first data object:
determining, based on the second amount of energy, whether a remaining amount of energy stored in the energy storage device after transmitting the first object is sufficient for receiving the second message;
setting an indicator to a first value in a case that the remaining amount of energy stored in the energy storage device after transmitting the first object is determined to be sufficient;
setting the indicator to a second value in a case that the remaining amount of energy stored in the energy storage device after transmitting the first object is determined to be insufficient; and
transmitting the first data object and the indicator to the other electronic device.
